(19) United States
(12) Patent Application Publication
(10) Pub. No.: US 2018/0062967 A1
(43) Pub. Date: Mar. 1, 2018

(54) Apparatus and Method for Providing Power to Machine Measurement Devices via Data Communication Network

(71) Applicant: epro GmbH, Gronau (DE)

(72) Inventors: Thomas Wewers, Gronau (DE); Christian Pliete, Ochtrup (DE); Raphael Wittmund, Heek (DE); Sven Wermers, Gronau (DE)

(73) Assignee: epro GmbH, Gronau (DE)

(21) Appl. No.: 15/245,630

(22) Filed: Aug. 24, 2016

(51) Int. Cl. H04L 12/26

(52) U.S. Cl. CPC H04L 43/12; H04L 43/08

(57) ABSTRACT

A machine health management system incorporates machine measurement units that are connected via Power Over Ethernet (PoE) to a central logic unit. Each measurement unit includes one or more sensor modules to which sensors are connected, or one or more output modules to which output devices are connected, or a combination of sensor modules and output modules. The energy needed to power the measurement units comes through the PoE network. Sensor signals generated by the sensors are digitalized and may be analyzed in the sensor modules. Raw data, and in some cases preprocessed data, are transported over the Ethernet network to the central logic unit, where the data is analyzed and/or combined with other data to perform prediction analysis, build decisions and possibly implement protection solutions, predict performance of the machine/system, or control the machine/system.

### FIELD

This invention relates to the field of data collection for machine health management and control. More particularly, this invention relates to a system for providing power to machine data collection devices through data communication networks.

### BACKGROUND

Monitoring and control of complex industrial machines generally requires many sensors of various types (vibration, temperature, pressure, etc.) and control devices (i.e., for switches, valves and actuators) distributed at various locations on or near the machine. Typically, such sensors and control devices are connected to monitoring and control systems in an industrial plant via a communication network. Disadvantages associated with prior communication networks in such applications include:
data transfer distance is limited;
many power supplies are required to power widely distributed sensors and control devices, which contributes to higher costs;
the length of signal lines between sensors and sensor modules tends to be long, contributing to noise problems on low-amplitude signals; and
because the conversion from analog signals to digital signals occurs at the sensor module, long signal lines between sensors and sensor modules further increase the probability of noise.

What is needed, therefore, is a machine monitoring and control network that alleviates the problems associated with fieldbus networks.

### SUMMARY

The above and other needs are met by a machine health management system that incorporates machine measurement units that are connected via Power Over Ethernet (PoE) to a central logic unit. Each measurement unit includes one or more sensor modules to which sensors are connected and/or one or more output modules to which output devices are connected. Examples of sensors include eddy current sensors, piezo electric sensors, seismic probe sensors, Linear Variable Differential Transformer (LVDT) sensors, and temperature sensors. Examples of output devices include relays, analog voltage, and analog current. The energy needed to power the measurement units comes through the PoE network.

Sensor signals generated by the sensors are digitalized and may be analyzed in the sensor modules. Raw data, and in some cases preprocessed data, are transported over the Ethernet network to the central logic unit. At the central logic unit, data is analyzed and/or combined with other data to perform prediction analysis, build decisions and possibly implement protection solutions, predict performance of the machine/system, or control the machine/system.

Examples of protection solutions include switching off a machine/system based on alarm values, generating warnings for upper systems, and voting between different values. Examples of prediction analysis include analyzing the raw data (PeakVue, FFT, comparisons to good, etc.) in the measurement module or in the central logic unit and reporting the health of the machine/system to plan maintenance service intervals. An example of a control solution is to combine different inputs and outputs to follow the control sequence and make decisions about whether to allow a system run in the programmed way.

Use of PoE in a control network may be separated from a standard office Ethernet so that deterministic protocols may be implemented. In various embodiments, both deterministic and standard Ethernet protocols may be used, depending on whether the application is for prediction or protection or other.

As described in more detail hereinafter, various embodiments of the invention are directed to a machine measurement system for collecting data that is indicative of operational conditions of machines in an industrial setting. One preferred embodiment of the system includes a central logic unit, a first Ethernet network switch, and one or more first sensor modules. The central logic unit, which is in communication with an Ethernet network, receives and processes the machine data, which may include machine prediction data, machine protection data, and machine control data. The first Ethernet network switch, which is in communication with the central logic unit via the Ethernet network, includes an internal power supply and one or more Power over Ethernet (PoE) ports that are operable to communicate data and provide power to connected devices. Each first sensor module includes a sensor interface for providing an electrical connection to a sensor, and a PoE port connected to one of the PoE ports of the first Ethernet network switch. The PoE port of each first sensor module communicates data to and receives power from the first Ethernet network switch.

In some embodiments, the first Ethernet network switch and the first sensor modules are disposed within a measurement unit housing.

In some embodiments, the machine measurement system includes one or more first output modules. Each first output module includes an output interface for providing an electrical connection to an output device, and a PoE port connected to one of the PoE ports of the first Ethernet network switch. The PoE port of each first output module communicates data to and receives power from the first Ethernet network switch.

In some embodiments, the one or more first output modules are disposed within the measurement unit housing.

In some embodiments, the machine measurement system includes a second Ethernet network switch and one or more second sensor modules. The second Ethernet network switch, which has no internal power supply, includes a PoE port that is connected to one of the PoE ports of the first Ethernet switch for communicating data to and receiving power from the first Ethernet network switch. The second Ethernet network switch also includes one or more PoE ports that are operable to communicate data and provide power to devices connected to the second Ethernet network switch. Each of the second sensor modules includes a sensor interface for providing an electrical connection to a sensor, and a PoE port connected to one of the PoE ports of the second Ethernet network switch. The PoE port of each second sensor module communicates data to and receives power from the second Ethernet network switch.

In some embodiments, the second Ethernet network switch and the second sensor modules are disposed within the measurement unit housing.

In some embodiments, the sensor interface of each of the first sensor modules is operable to provide an electrical connection to an eddy current sensor, piezo electric sensor, seismic probe sensor, Linear Variable Differential Transformer (LVDT) sensor, voltage sensor, current sensor, temperature sensor or pressure sensor.

In some embodiments, the output interface of each of the first output modules is operable to provide an electrical connection to a relay, a switch, an actuator, a valve, a digital output, a voltage output, a current output, a linear position unit, and a step motor.

In some embodiments, the machine measurement system includes a third Ethernet network switch. The third Ethernet network switch includes an internal power supply, one or more PoE ports that communicate data and provide power to connected devices, a wireless module for wirelessly communicating data to and from the third Ethernet network switch, and one or more third sensor modules. Each of the third sensor modules include a sensor interface that provides an electrical connection to a sensor, and a PoE port connected to one of the PoE ports of the third Ethernet network switch. The PoE port of each third sensor module communicates data to and receives power from the third Ethernet network switch.

### BRIEF DESCRIPTION OF THE DRAWINGS

Other embodiments of the invention will become apparent by reference to the detailed description in conjunction with the FIGURES, wherein elements are not to scale so as to more clearly show the details, wherein like reference numbers indicate like elements throughout the several views.

FIG. 1 depicts a system for powering and communicating with various components of a machine measurement/control system via Power Over Ethernet according to a preferred embodiment.

### DETAILED DESCRIPTION

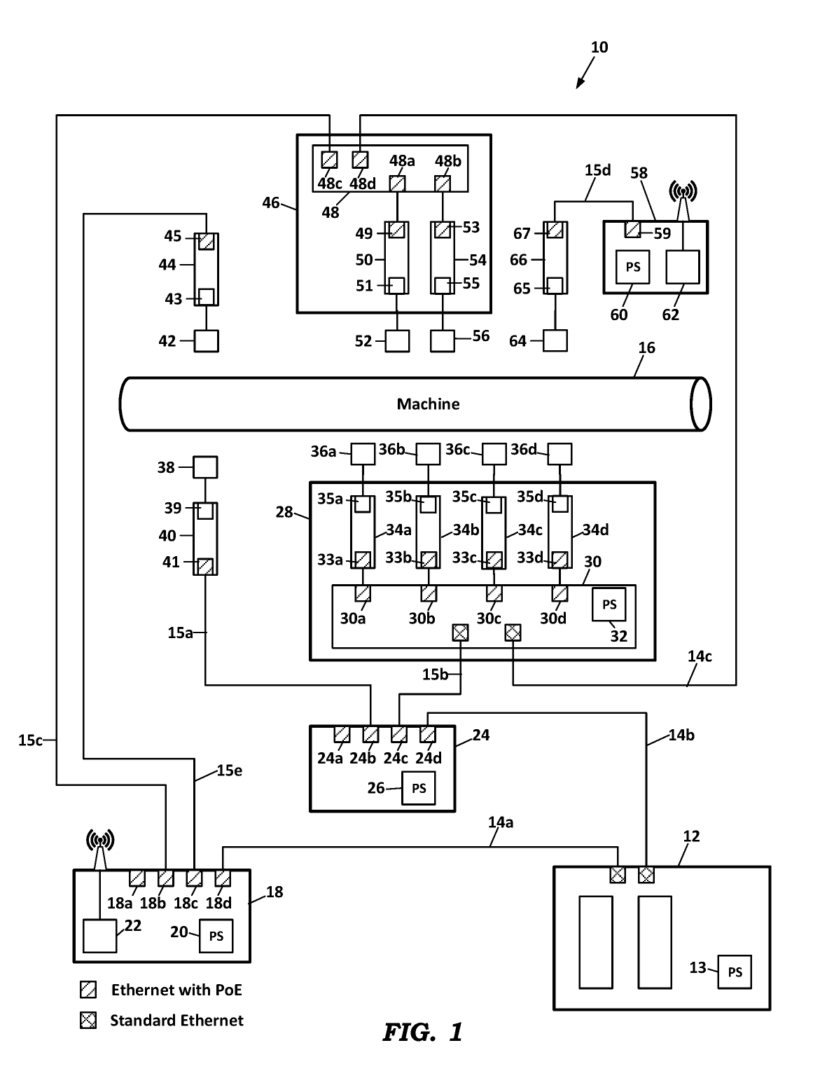

As shown in FIG. 1, a preferred embodiment of a machine measurement/control system 10 includes a central logic unit 12 that receives and processes data collected by various sensor modules or output modules associated with a machine 16 in an industrial plant. The central logic unit 12 is in communication with network switches 18 and 24 via a communication network, which in a preferred embodiment includes standard Ethernet cables 14a and 14b. In the preferred embodiment, the central logic unit 12 includes a power supply 13.

The network switches 18 and 24, which are powered by their own power supplies 20 and 26, provide Power Over Ethernet (PoE) to connected devices via a PoE Ethernet cable 15. The network switch 24 is preferably a wired Ethernet switch, whereas the switch 18 supports wireless network communications via a wireless module 22, in addition to wired communications. The switch 24 provides data communications and power to a vibration sensor module 40 via a PoE port 24b and the PoE cable 15a. The vibration sensor module 40 generates vibration data based on vibration signals received from a vibration sensor 38, such as a piezoelectric sensor. The vibration sensor module 40 includes a sensor interface 39 for connection to the sensor 38 and a PoE port 41 for connection to the PoE cable 15a. Disposed within the sensor module 40, between the sensor interface 39 and the PoE port 41, are signal conditioning circuitry and analog-to-digital conversion circuitry.

The switch 24 also provides data communications to a first measurement unit 28 via the PoE cable 15b. More specifically, the PoE cable 15b provides data communication to a network switch 30 which is a component of the first measurement unit 28. The switch 30, which has its own internal power supply 32, provides data communication and power via PoE ports 30a-30d to sensor modules and output modules 34a-34d that are components of the measurement/control unit 28. Each sensor and output module 34a-34d includes a PoE port 33a-33d. The sensor and output modules include a valve control actuator module 34a which is connected via a sensor interface 35a to a valve control actuator 36a, two vibration monitoring modules 34b and 34c which are connected via sensor interfaces 35b and 35c to vibration sensors 36b and 36c, and a voltage measurement module 34d that is connected via a sensor interface 35d to a voltage sensor 36d. The switch 30 and modules 34a-34d of the first measurement unit 28 are preferably housed in a single measurement unit housing.

The switch 18 provides data communications and power to a current measurement module 44 via the PoE connection 15e and the PoE port 45. The current measurement module 44 generates current data based on current measurement signals received via interface 43 from a current sensor 42.

The switch 18 also provides data communications and power to a second measurement unit 46 via the PoE port 18b and PoE cable 15c. More specifically, the PoE cable 15c provides data communication and power to a PoE port 48c of a network switch 48 that is a component of the second measurement unit 46. The switch 48, which does not have its own internal power supply, provides data communication and power via PoE ports 48a and 48b to PoE ports 49 and 53 of two sensor modules 50 and 54 that are components of the measurement/control unit 46. The sensor modules 50 and 54 comprise two vibration monitoring modules that generate vibration data based on vibration signals received via sensor interfaces 51 and 55 from vibration sensors 52 and 56, which may be piezoelectric sensors. The switch 48 and vibration monitoring units 50 and 54 of the second measurement unit 46 are preferably housed in a measurement unit housing. The switch 48 may also be in communication with the switch 30 via a standard Ethernet connection 14c.

In this exemplary embodiment, the system 10 also includes a wireless switch 58 that has its own internal power supply 60. The switch 58 provides data communications and power to a PoE port 67 of a tachometer module 66 via a PoE port 59 and PoE cable 15d. The tachometer module 66 generates tachometer data based on tachometer pulses received via sensor interface 65 from a tachometer sensor 64.

There are several advantages of the machine measurement/control system 10 depicted in FIG. 1 over conventional systems, such as industrial networks that employ Fieldbus wiring. Those advantages include:
data can be transferred over longer distances;
widely distributed measurements can be made using fewer power supplies;
the distance between sensors and sensor modules can be shorter, thereby lessening the probability of picking up noise on low amplitude signals;
the conversion from analog signals to digital signals occurs closer to the sensors, further reducing probability of noise; and
lower installation costs.

Another advantage is scalability. For example, in one embodiment, a grouping of two, three, four, five, six or more sensor or output modules can be grouped together in a single housing and connected as a unit to the communication network. Inside the housing is a PoE network switch that connects the machine measurement/control Ethernet network with the PoE network. The modules grouped in the housing need one or two Ethernet inputs (ring structure for availability) and a power input. Internally to the housing, the POE switch supplies power to the individual Sensor over Ethernet (SoE), Actor over Ethernet (AoE), Input over Ethernet (IoE), Vibration over Ethernet (VoE), or Functional Safety over Ethernet (FSoE) modules. In this context, an “actor” refers to an active component in a process or control unit, such as a valve or a relay. External network connections can be accomplished via wireless, optical Ethernet or other standard technology.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A machine measurement system for collecting data that is indicative of operational conditions of machines in an industrial setting, the system comprising:
a central logic unit that receives the data that is indicative of the operational conditions of the machines, the central logic unit in communication with an Ethernet network;
a first Ethernet network switch in communication with the central logic unit via the Ethernet network, the first Ethernet network switch comprising:
an internal power supply for supplying power to the first Ethernet network switch; and
one or more Power over Ethernet (PoE) ports that are operable to communicate data and provide power to devices connected thereto; and
one or more first sensor modules, each comprising:
a sensor interface for providing an electrical connection to a sensor; and
a PoE port connected to one of the one or more PoE ports of the first Ethernet network switch, the PoE port of each first sensor module for communicating data to and receiving power from the first Ethernet network switch.

2. The machine measurement system of claim 1 wherein each first sensor module and the sensor to which it is electrically connected are integrated into one housing.

3. The machine measurement system of claim 1 further comprising a measurement unit housing, wherein
the first Ethernet network switch is disposed within the measurement unit housing and the first Ethernet network switch includes a plurality of PoE ports, and
the one or more first sensor modules comprise a plurality of first sensor modules disposed within the measurement unit housing, wherein each of the PoE ports of the plurality of first sensor modules are connected to a corresponding one of the plurality of PoE ports of the first Ethernet network switch.

4. The machine measurement system of claim 1 further comprising one or more first output modules, each first output module comprising:
an output interface for providing an electrical connection to an output device; and
a PoE port connected to one of the one or more PoE ports of the first Ethernet network switch, the PoE port of each first output module for communicating data to and receiving power from the first Ethernet network switch.

5. The machine measurement system of claim 4 wherein each first output module and the output device to which it is electrically connected are integrated into one housing.

6. The machine measurement system of claim 3 further comprising one or more first output modules disposed within the measurement unit housing, each first output module comprising:
an output interface for providing an electrical connection to an output device; and
a PoE port connected to a corresponding one of the plurality of PoE ports of the first Ethernet network switch, the PoE port of each first output module for communicating data to and receiving power from the first Ethernet network switch.

7. The machine measurement system of claim 1 further comprising:
a second Ethernet network switch having no internal power supply, the second Ethernet network switch comprising:
a plurality of PoE ports comprising:
a PoE port connected to one of the PoE ports of the first Ethernet switch, for communicating data to and receiving power from the first Ethernet network switch; and
one or more PoE ports that are operable to communicate data and provide power to devices connected thereto; and
one or more second sensor modules, each comprising:
a sensor interface for providing an electrical connection to a sensor; and
a PoE port connected to one of the one or more PoE ports of the second Ethernet network switch, the PoE port of each second sensor module for communicating data to and receiving power from the second Ethernet network switch.

8. The machine measurement system of claim 7 wherein each second sensor module and the sensor to which it is electrically connected are integrated into one housing.

9. The machine measurement system of claim 7 further comprising a measurement unit housing, and wherein the second Ethernet network switch and the one or more second sensor modules are disposed within the measurement unit housing.

10. The machine measurement system of claim 7 further comprising one or more second output modules, each second output module comprising:
an output interface for providing an electrical connection to an output device; and
a PoE port connected to one of the one or more PoE ports of the second Ethernet network switch, the PoE port of each second output module for communicating data to and receiving power from the second Ethernet network switch.

11. The machine measurement system of claim 1 wherein the sensor interface of each of the one or more first sensor modules is operable to provide an electrical connection to one or more of an eddy current sensor, piezo electric sensor, seismic probe sensor, Linear Variable Differential Transformer (LVDT) sensor, voltage sensor, current sensor, temperature sensor and pressure sensor.

12. The machine measurement system of claim 4 wherein the output interface of each of the one or more first output modules is operable to provide an electrical connection to one or more of a relay, a digital output, a voltage output, a current output, a valve, a linear position unit, and a step motor.

13. The machine measurement system of claim 1 further comprising:
a third Ethernet network switch comprising:
an internal power supply for supplying power to the third Ethernet network switch;
one or more PoE ports that are operable to communicate data and provide power to devices connected thereto; and
a wireless module for wirelessly communicating data to and from the third Ethernet network switch via a wireless communication network; and
one or more third sensor modules, each comprising:
a sensor interface for providing an electrical connection to a sensor; and
a PoE port connected to one of the one or more PoE ports of the third Ethernet network switch, the PoE port of each third sensor module for communicating data to and receiving power from the third Ethernet network switch.

14. The machine measurement system of claim 13 further comprising one or more third output modules, each third output module comprising:
an output interface for providing an electrical connection to an output device; and
a PoE port connected to one of the one or more PoE ports of the third Ethernet network switch, the PoE port of each third output module for communicating data to and receiving power from the third Ethernet network switch.

15. The machine measurement system of claim 1 wherein the central logic unit is operable to receive and process data selected from the group consisting of machine prediction data, machine protection data, and machine control data.

16. The machine measurement system of claim 1 wherein the central logic unit is operable to receive the data and make the data available for processing by an external data analysis system which returns processed data to the central logic unit, wherein the processed data is selected from the group consisting of machine prediction data, machine protection data, and machine control data.
